(19) United States
(12) Patent Application Publication
(10) Pub. No.: US 2026/0050061 A1
(43) Pub. Date: Feb. 19, 2026

(54) RADAR DEVICE

(71) Applicant: STANLEY ELECTRIC CO., LTD., Tokyo (JP)

(72) Inventor: Masayuki KANECHIKA, Tokyo (JP)

(21) Appl. No.: 18/747,402

(22) Filed: Jun. 18, 2024

(30) Foreign Application Priority Data
Jun. 23, 2023 (JP) 2023-103407

(51) Int. Cl. G01S 7/03; H01P 1/02

(52) U.S. Cl. CPC G01S 7/032; H01P 1/022

(57) ABSTRACT

A radar device includes a radar transmitting and receiving millimeter-wave electromagnetic waves, a storage storing the radar and including an opening portion through which the electromagnetic waves radiated from the radar pass, a light guide plate being in contact with a periphery of the opening portion of the storage and covering an entire of the opening portion, and a light emitter causing light to be incident on a light entrance surface being a surface on which light is incident among lateral surfaces of the light guide plate.

### CROSS-REFERENCE TO RELATED APPLICATIONS

This application claims the benefit of Japanese Patent Application No. 2023-103407, filed on Jun. 23, 2023, the entire disclosure of which is incorporated by reference herein.

### FIELD OF THE INVENTION

This application relates generally to a radar device.

### BACKGROUND OF THE INVENTION

Radar using millimeter waves (millimeter wave radar) has been known in the related art, and vehicles equipped with a millimeter wave radar have also been put into practical use. When a millimeter wave radar is installed in a vehicle, a radar device is often hidden with a cover in order to prevent visual quality from deteriorating (prevent designability from deteriorating). For example, in a lamp body for a vehicle disclosed in Unexamined Japanese Patent Application Publication No. 2020-194710, a light guide lens is installed at the back of an outer lens serving as a cover, and a millimeter wave radar is further installed at the back of the light guide lens. With such a structure, the heat dissipation property and serviceability of the millimeter wave radar are improved, and the millimeter wave radar is difficult to be visible from the outside, thereby achieving good designability.

### SUMMARY OF THE INVENTION

An aspect of a radar device according to the present disclosure includes:
a radar transmitting and receiving millimeter-wave electromagnetic waves;
a storage storing the radar and including an opening portion through which the electromagnetic waves radiated from the radar pass;
a light guide plate being in contact with a periphery of the opening portion of the storage and covering an entire of the opening portion; and
a light emitter causing light to be incident on a light entrance surface being a surface on which light is incident among lateral surfaces of the light guide plate.

### BRIEF DESCRIPTION OF DRAWINGS

A more complete understanding of this application can be obtained when the following detailed description is considered in conjunction with the following drawings, in which:

FIG. 1 is a side view of a radar device according to Embodiment 1;

FIG. 2 is a cross-sectional view of the radar device according to Embodiment 1;

FIG. 3 is a perspective view of a storage according to Embodiment 1, viewed diagonally from above;

FIG. 4 is a top view of the radar device according to Embodiment 1;

FIG. 5 is a view schematically illustrating how millimeter waves radiated from a radar travel;

FIG. 6 is a side view of a radar device according to Embodiment 2;

FIG. 7 is a side view of a radar device according to Embodiment 3; and

FIG. 8 is a side view of a radar device according to Embodiment 4.

### DETAILED DESCRIPTION OF THE INVENTION

Embodiments of the present disclosure are described below with reference to the drawings Note that the same reference numerals are given to the same or corresponding parts in the drawings.

### Embodiment 1

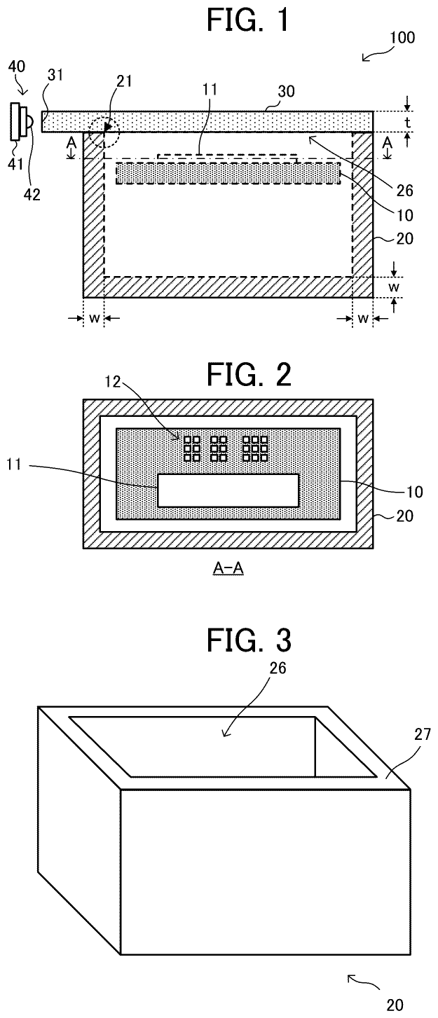

As illustrated in a side view in FIG. 1, a radar device 100 according to Embodiment 1 includes a radar 10 that transmits and receives millimeter-wave electromagnetic waves, a storage 20 having a box shape with one surface open and storing the radar 10, a light guide plate 30 that hides the radar 10 and emits light by light from a light emitter 40, and the light emitter 40 that causes light to be incident on the light guide plate 30. Note that the inner lateral surfaces and bottom surface of the storage 20 and the radar 10 are not visible from the outside of the storage 20, and thus are indicated by broken lines in FIG. 1.

FIG. 2 is a cross-sectional view taken along line A-A in FIG. 1. As illustrated in FIG. 2, a driver 11 and an antenna 12 are mounted on a substrate of the radar 10. The driver 11 is mounted with a transmission circuit and a reception circuit of a millimeter wave radar. The antenna 12 is mounted with a transmission antenna for radiating millimeter-wave electromagnetic waves and a reception antenna for receiving the electromagnetic waves (reflected waves) radiated from the transmission antenna and reflected by a target. The storage 20 is a case of the radar device 100, and is made of a conductor (for example, die-cast aluminum). The storage 20 has a multifaceted shape with one surface open, and a thickness w of each surface is, for example, 1.5 mm. An open portion of the storage 20 is defined as an opening portion 26. The storage 20 stores the radar 10 so that the antenna 12 of the radar 10 faces the opening portion 26 side. The storage 20 suppresses the electromagnetic waves transmitted from the radar 10 from being radiated from a portion other than the opening portion 26 of the storage 20. In FIGS. 1 and 2, the storage 20 has a rectangular parallelepiped shape, and the thickness w of each surface has a constant value; however, the shape and thickness of the storage 20 are not limited thereto. The storage 20 may have a shape other than a rectangular parallelepiped as long as the storage 20 can store the radar 10 and suppress electromagnetic waves transmitted from the radar 10 from being radiated from a portion other than the opening portion 26, and the thickness may not also be constant.

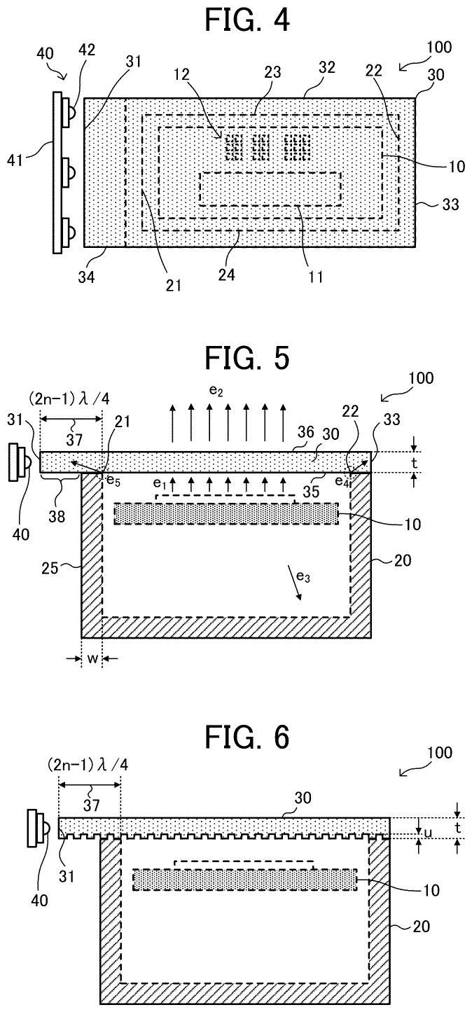

The light guide plate 30 is made of resin and has a plate shape. As illustrated in FIG. 3, when the light guide plate 30 is placed on a surface of the storage 20 on the opening portion 26 side, an end surface 27 of each surface of the storage 20 surrounding the opening portion 26 is made so that the end surface 27 and the light guide plate 30 are in contact with each other without any gap. As illustrated in FIG. 1, the light guide plate 30 is disposed to be in contact with the end surface 27 existing around the opening portion 26 of the storage 20 without any gap, and to close the entire opening portion 26. The light guide plate 30 directly faces the antenna 12 of the radar 10. FIG. 4 is a top view of the radar device 100, in which the light guide plate 30 is disposed to close the opening portion 26 at the top of the storage 20, when viewed from above. When light enters a light entrance surface 31 being one of lateral surfaces of the light guide plate 30, the light is diffused inside the light guide plate 30, and the entire surface of the light guide plate 30 emits light. The material of the light guide plate 30 is a dielectric material such as polycarbonate, acrylic resin, or polypropylene.

As illustrated in FIGS. 1 and 4, the light emitter 40 includes a light source module board 41 and a light-emitting element 42 mounted thereon. The light emitter 40 emits light to the light entrance surface 31 of the light guide plate 30 and causes the light guide plate 30 to emit light. As illustrated in FIG. 4, the light-emitting element 42 may be one in which a plurality of light-emitting diodes (LEDs) is mounted in a line, or may be a linear light source such as a cold cathode fluorescent tube or a hot cathode fluorescent tube.

As the light guide plate 30 emits light by light from the light emitter 40, the radar 10 is hidden by the emitted light guide plate 30 and is not exposed. The light guide plate 30 is visually recognized from the outside as a lighting such as a small light (position lamp, headlight), a tail lamp (signal lamp), or a blinker (direction indicator). Consequently, the radar device 100 is visually recognized as a normal vehicle lighting device in appearance, and even though the radar device 100 has a radar function, the existence of the radar is hidden, and the visual quality of the radar device 100 can be prevented from deteriorating due to the radar. By using the light emission of the light guide plate 30 as, for example, a vehicle lighting function, the number of members such as a cover for hiding the radar 10 can be reduced, and radar performance can be suppressed from being degraded.

Three lateral surfaces of the light guide plate 30 other than the light entrance surface 31, that is, lateral surfaces 32, 33, and 34 illustrated in FIG. 4 are covered with a conductor such as by being plated with aluminum. Therefore, the millimeter waves incident on the light guide plate 30 are reflected at the lateral surfaces 32, 33, and 34, and do not leak from the lateral surfaces 32, 33, and 34. The light entrance surface 31 is covered with no conductor (subjected to no aluminum plating or the like) (because light from the light emitter 40 needs not enter).

Therefore, the millimeter waves entering the light guide plate 30 may leak to the outside from the light entrance surface 31. However, as described below, since a distance is provided between an upper end 21 indicated by an arrow in FIG. 1 and the light entrance surface 31 so that the millimeter waves are canceled out in opposite phases, leakage of the millimeter waves from the light entrance surface 31 is suppressed.

The light guide plate 30 may not be placed on the end surface 27 of the storage 20. For example, by extending lateral surfaces of the storage 20 upward to face the lateral surfaces 32, 33, and 34 of the light guide plate 30, respectively, the light guide plate 30 may be installed while entering the storage 20. In this case, the lateral surfaces 32, 33, and 34 face the inner lateral surfaces (for example, die-cast aluminum) of the storage 20. Consequently, even though the lateral surfaces 32, 33, and 34 are not plated with aluminum, the millimeter waves incident on the light guide plate 30 are reflected on the inner lateral surfaces of the storage 20 facing the lateral surfaces 32, 33, and 34, and do not leak to the outside of the storage 20.

The electromagnetic waves transmitted from the radar 10 are, for example, millimeter waves in a 79 GHz band, but the frequency is arbitrary as long as the electromagnetic waves are millimeter waves. For example, as a frequency for specific low power radio stations for millimeter wave radar, three types of frequency bands of (1) Frequency exceeding 60 GHz and below 61 GHZ, (2) Frequency exceeding 76 GHz and below 77 GHz, and (3) Frequency exceeding 77 GHz and below 81 GHz are defined; however, electromagnetic waves with any frequency among the above frequencies can be used as millimeter waves transmitted and received by the radar 10.

When the frequency of the millimeter waves transmitted from the radar 10 is expressed by f (Hz) and the speed of light is expressed by c (m/s), a free space wavelength λ₀ (m) of the millimeter waves is expressed by the following equation (1).

$${λ}_{0} = c / f \qquad ( 1 )$$

When the relative permittivity of the light guide plate 30 is expressed by εᵣ, an effective wavelength λ (m) of the millimeter waves transmitted through the inside of the light guide plate 30 is expressed by the following equation (2).

$$λ = {λ}_{0} / {( {ε}_{r} )}^{1 / 2} \qquad ( 2 )$$

For example, when f=79 GHz and εᵣ=3.0, the free space wavelength λ₀ and the effective wavelength λ in the light guide plate 30 are calculated as follows. Note that each numerical value is basically expressed with two significant digits below.

$${λ}_{0} = c / f = 3.00 \times 1 {0}^{8} / 79 \times 1 {0}^{9} = 3.8 ( mm )$$

$$λ = {λ}_{0} / {( {ε}_{r} )}^{1 / 2} = 3.8 \times 1 {0}^{- 3} / 1.732 = 2.2 ( mm )$$

FIG. 5 is a diagram schematically showing how millimeter waves e₁ radiated from the radar 10 travel inside and outside the radar device 100. Approximately 95% of the millimeter waves e₁ radiated from the antenna 12 of the radar 10 travel straight toward the front (light guide plate 30), pass through the light guide plate 30, and are radiated to the outside as millimeter waves e₂.

Note that since most of the millimeter waves e₁ is radiated perpendicularly to a back surface 35 (surface that makes a boundary between an inner space of the storage 20 and the light guide plate 30) of the light guide plate 30 and a surface 36 (surface that makes a boundary between an external space of the radar device 100 and the light guide plate 30) of the light guide plate 30, the millimeter waves e₁ are less reflected at the back surface 35 and the surface 36 of the light guide plate 30 and approximately 5% of the millimeter waves e₁ radiated from the antenna 12 are reflected. By setting a thickness t of the light guide plate 30 to a positive integer multiple of λ/2, the millimeter waves entering the light guide plate 30 and the reflected waves reflected by the surface 36 of the light guide plate 30 are aligned in phase, so that the amount of attenuation of the millimeter waves within the light guide plate 30 is minimized. Consequently, the thickness t of the light guide plate 30 is desirably a positive integer multiple of λ/2.

However, it has been confirmed by simulation that an allowable range of ±5% (range in which the electromagnetic waves radiated from the radar 10 are not affected) exists in an optimal thickness t of the light guide plate 30, so the thickness t can be actually set in a range of a positive integer multiple of λ/2±5%.

Among the millimeter waves e₁ radiated from the antenna 12, those that do not travel to the front (side lobes, millimeter waves reflected by the light guide plate 30, or the like) are diffused inside the storage 20. For example, millimeter waves e₃ traveling in a direction opposite to the light guide plate 30 are reflected or absorbed by the bottom surface and lateral surfaces of the storage 20.

The light guide plate 30 and the end surface 27 of the storage 20 are in contact with each other without any gap, and among the electromagnetic waves radiated from the antenna 12, electromagnetic waves that travel in the direction of the opening portion 26 but are not emitted to the outside are disturbed at inner ends of the storage 20, enter the light guide plate 30, and travel laterally. For example, millimeter waves e₄ that enter the inside of the light guide plate 30 from an upper end 22 on a lateral surface on an opposite side from the light emitter 40 among the inner lateral surfaces of the storage 20 are reflected or absorbed by the aluminum plating or the like present on the lateral surface 33 of the light guide plate. Furthermore, as illustrated in FIG. 4, millimeter waves that enter the inside of the light guide plate 30 from upper ends (upper ends 23 and 24 on the inner lateral surfaces of the storage 20 illustrated in FIG. 4) on a lateral surface, which connects a lateral surface located at the shortest distance from the light emitter 40 and a lateral surface located at the longest distance from the light emitter 40 among the inner lateral surfaces of the storage 20, are reflected or absorbed by the aluminum plating or the like present on the lateral surfaces 32 and 34 of the light guide plate 30 illustrated in FIG. 4.

Since millimeter waves that enter the light guide plate 30 from the upper end 21 of the inner ends of the storage 20 and travel laterally do not travel in the direction of the lateral surfaces 32, 33, and 34 (travel in the direction of the light entrance surface 31), the millimeter waves are neither reflected nor absorbed. Consequently, since components of the millimeter waves that enter the light guide plate 30 from the upper end 21 and travel in the direction of the light entrance surface 31 are increased, the present embodiment introduces a mechanism for suppressing this millimeter waves by the distance from the upper end 21 (starting point) to the light entrance surface 31 (end point). Specifically, as illustrated in FIG. 5, a distance of (2n−1) λ/4 is provided as a suppression distance 37 between the upper end 21 on the inner lateral surface of the storage 20, which exists at the shortest distance from the light emitter 40, and the light entrance surface 31. Due to the existence of the suppression distance 37, millimeter waves es having entered the inside of the light guide plate 30 from the upper end 21 have opposite phases when reflected by the light entrance surface 31 and cancel with each other, so that millimeter waves leaking toward the light emitter 40 from the light entrance surface 31 can be suppressed. Note that n is any positive integer, that is, the suppression distance 37 is a positive odd multiple of λ/4.

For example, in a case where the millimeter wave frequency is 79 GHZ, since λ=2.2 mm as described above, when n is 1, the suppression distance 37 is 0.55 mm (=2.2/4). Since it has been confirmed by simulation that an allowable range of ±15% exists in the suppression distance 37, the suppression distance 37 can be set in a range from 0.47 mm (=2.2/4×0.85) to 0.63 mm (=2.2/4×1.15) in this case.

Likewise, for example, when n=2, the suppression distance 37 is 1.65 mm (=3×2.2/4). Since the allowable range of ±15% exists in the suppression distance 37, the suppression distance 37 can be set in a range from 1.4 mm (=3×2.2/4×0.85) to 1.9 mm (=3×2.2/4×1.15) in this case.

That is, when the thickness w of the storage 20 is 1.5 mm, the suppression distance 37 is set using n=1, so that the light entrance surface 31 of the light guide plate 30 can be made more recessed than an outer lateral surface 25 of the storage 20. Furthermore, the suppression distance 37 is set using n=2, so that the position of the outer lateral surface of the storage 20 and the position of the light entrance surface 31 of the light guide plate 30 can be aligned.

In a case where the thickness w of the storage 20 is 1.5 mm, when n is an integer of 3 or more, since the suppression distance 37 is longer than the thickness w of the storage 20, the light entrance surface 31 side of the light guide plate 30 protrudes more than the outer lateral surface 25 of the storage 20 as illustrated in FIG. 5. A back surface 38 at the protruding portion of the light guide plate 30 may also be covered with a conductor, such as by being plated with aluminum. By covering the back surface 38 at the protruding portion of the light guide plate 30 with a conductor, millimeter waves incident on the light guide plate 30 can be from leaking from the back surface 38.

Lighting devices with a radar device in the related art have an inner lens for hiding the radar device in order to improve visual quality, so radar performance may be degraded because the radar output passes through the front cover of a radar case and passes through the inner lens and an outer lens. However, as described above, in the radar device 100, since the light guide plate 30 also serves as a cover that covers the radar 10, there is no need to provide a separate cover other than the light guide plate 30. Consequently, the radar device 100 can hide the radar 10 with fewer members, and can prevent degradation of radar performance. Furthermore, by providing the suppression distance 37 in the light guide plate 30, electromagnetic waves that travel toward the light emitter 40 through the light guide plate 30 among electromagnetic waves transmitted from the radar 10 are attenuated. Consequently, the electromagnetic waves transmitted from the radar 10 can be prevented from turning into noise to enter the light emitter 40 and disrupting light entering the light guide plate 30.

### Embodiment 2

As illustrated in FIG. 6, the light guide plate 30 can be provided on the back surface thereof with unevenness to improve light emission efficiency. The unevenness illustrated in FIG. 6 is obtained by disposing grooves each having a depth u at regular intervals on the light guide plate 30 having the thickness t; however, conversely, the unevenness may be obtained by disposing protrusions each having a height u at regular intervals on the light guide plate 30 having the thickness t.

When the effective wavelength within the light guide plate 30 of the electromagnetic waves radiated from the radar 10 is λ, the thickness t of the light guide plate 30 is desirably a positive integer multiple of λ/2 as described above in order to optimize the transmission of the electromagnetic waves radiated from the radar 10.

The depth u (or height u) is preferably large enough not to affect the electromagnetic waves radiated from the radar 10, but it has been confirmed by simulation that by setting u to a magnitude of λ/20 or less, the influence on the electromagnetic waves can be ignored. Consequently, the depth (or height) of the unevenness provided on the light guide plate 30 is desirably equal to or less than 1/20 of the effective wavelength λ within the light guide plate 30 of the electromagnetic waves radiated from the radar 10.

Even in the case of using the light guide plate 30 provided with unevenness, as illustrated in FIG. 6, the suppression distance 37 of (2n−1) λ/4 is provided as a distance between the upper end 21 on the inner lateral surface of the storage 20, which exists at the shortest distance from the light emitter 40, and the light entrance surface 31 of the light guide plate 30 as described above, so that millimeter waves leaking toward the light emitter 40 from the light entrance surface 31 can be suppressed.

As described above, the radar device 100 according to Embodiment 2 can improve the light emission efficiency of the light guide plate 30 by providing unevenness on the back surface of the light guide plate 30. By setting the thickness (depth or height) u of the unevenness to λ/20 or less, the influence on the electromagnetic waves radiated from the radar 10 can be ignored, uneven light emission can be removed, and visual quality can be further improved.

### Embodiment 3

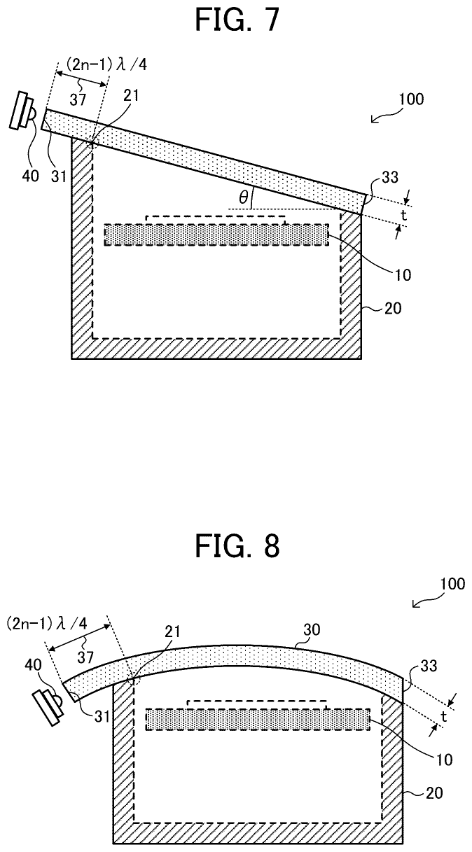

The above-described embodiments illustrate the radar device 100 having a shape in which the light guide plate 30 protrudes perpendicularly from the lateral surface of the storage 20; however, the direction in which the light guide plate 30 protrudes from the storage 20 needs not be perpendicular to the lateral surface of the storage 20. For example, the radar device 100 may have a shape in which the light guide plate 30 protrudes obliquely from the end of the storage 20, as illustrated in FIG. 7.

The light guide plate 30 serves as a vehicle lighting as described above, but depending on a vehicle body, there may be restrictions on the position and orientation in which the radar device 100 can be installed. Even in such a case, by inclining the direction of the light guide plate 30 (in a direction other than perpendicular to the lateral surface of the storage 20), the degree of freedom in a direction in which the lighting (position lamp, tail lamp, or the like) illuminates can be increased. In particular, by setting an angle (θ illustrated in FIG. 7), at which the light guide plate 30 is inclined, between 0° and 30°, the light guide plate 30 can be inclined without significantly attenuating radar output.

Even when the direction of the light guide plate 30 is oblique, as illustrated in FIG. 7, the suppression distance 37 of (2n−1) λ/4 is provided as a distance between the upper end 21 on the inner lateral surface of the storage 20, which exists at the shortest distance from the light emitter 40, and the light entrance surface 31 of the light guide plate 30 as described above, so that millimeter waves leaking toward the light emitter 40 from the light entrance surface 31 can be suppressed.

As described above, the radar device 100 according to Embodiment 3 can increase the degree of freedom in a direction, in which the light guide plate 30 serving as a lighting (position lamp, tail lamp, or the like) illuminates, by making the installation angle of the light guide plate 30 flexible.

### Embodiment 4

The light guide plate 30 may also be bent as illustrated in FIG. 8. When the light guide plate 30 is bent, light from the light emitter 40 is spread and emitted due to the influence of the bending of the light guide plate 30, so that the visibility of a lighting (position lamp, tail lamp, or the like) implemented with the light guide plate 30 can be improved. By using the bent light guide plate 30, the effect of further improving the visual quality of the radar device 100 in appearance can be expected.

Even in the case of using the bent light guide plate 30, as illustrated in FIG. 8, the suppression distance 37 of (2n−1) λ/4 is provided as a distance between the upper end 21 on the inner lateral surface of the storage 20, which exists at the shortest distance from the light emitter 40, and the light entrance surface 31 of the light guide plate 30 as described above, so that millimeter waves leaking toward the light emitter 40 from the light entrance surface 31 can be suppressed.

As described above, the radar device 100 according to Embodiment 4 controls the light distribution of a lighting (position lamp, tail lamp, or the like) implemented with the light guide plate 30 by bending the light guide plate 30, thereby improving visibility and further improving visual quality in appearance.

Regarding the inclination of the lateral surface of the light guide plate 30, FIG. 7 illustrates an example in which the inclination of the lateral surface 33 is different from the inclination of the lateral surface of the storage 20, and FIG. 8 illustrates an example in which the inclination of the lateral surface 33 matches the inclination of the lateral surface of the storage 20. The inclination of the lateral surface of the light guide plate 30 illustrated in these drawings is an example, and as long as aluminum plating is applied to prevent millimeter waves from leaking, a manner in which the lateral surface of the light guide plate 30 is inclined is arbitrary.

When the light guide plate 30 (the lateral surfaces 32, 33, and 34 side other than the light entrance surface 31) protrudes from the outer lateral surface of the storage 20, the back surface 35 at the portion protruding from the outer lateral surface of the storage 20 (as with the lateral surfaces 32, 33, and 34) may also be covered with a conductor, such as by being plated with aluminum, thereby preventing millimeter waves from leaking.

Although a plurality of embodiments has been described above, these embodiments can also be combined. For example, a combination of Embodiment 2 and Embodiment 3 may configure a radar device 100 in which the light guide plate 30 provided on the back surface thereof with unevenness is installed in an oblique direction with respect to the lateral surface of the storage 20.

The radar device 100 illustrated in each of the embodiments described above can be used, for example, for a vehicle lighting device such as a light with built-in radar installed in an automobile (signal light or daylight/position light in a headlight with built-in radar, signal light in a tail lamp with built-in radar, or the like).

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims. along with the full range of equivalents to which such claims are entitled.

1. A radar device comprising:
a radar transmitting and receiving millimeter-wave electromagnetic waves;
a storage storing the radar and including an opening portion through which the electromagnetic waves radiated from the radar pass;
a light guide plate being in contact with a periphery of the opening portion of the storage and covering an entire of the opening portion; and
a light emitter causing light to be incident on a light entrance surface being a surface on which light is incident among lateral surfaces of the light guide plate.

2. The radar device according to claim 1, wherein in a case where an effective wavelength within the light guide plate of the electromagnetic waves radiated from the radar is λ, in the light guide plate, a suppression distance of a positive odd multiple of λ/4 is provided between the light entrance surface and an upper end on a lateral surface existing at the shortest distance from the light emitter among inner lateral surfaces of the storage.

3. The radar device according to claim 2, wherein the lateral surfaces of the light guide plate other than the light entrance surface are covered with a conductor.

4. The radar device according to claim 3, wherein the light guide plate has a thickness corresponding to a positive integer multiple of λ/2.

5. The radar device according to claim 4, wherein the light guide plate is provided on a back surface thereof with unevenness with a thickness of λ/20 or less.

6. The radar device according to claim 1, wherein the light guide plate is bent.

7. The radar device according to claim 2, wherein the light guide plate is bent.

8. The radar device according to claim 3, wherein the light guide plate is bent.

9. The radar device according to claim 4, wherein the light guide plate is bent.

10. The radar device according to claim 5, wherein the light guide plate is bent.
